(19) United States
(12) Patent Application Publication
(10) Pub. No.: US 2009/0303751 A1
(43) Pub. Date: Dec. 10, 2009

(54) POWER SOURCE APPARATUS AND CONTROL METHOD THEREOF

(75) Inventor: Hiroshi USUI, Niiza-shi (JP)

Correspondence Address: OBLON, SPIVAK, MCCLELLAND MAIER & NEUSTADT, L.L.P., 1940 DUKE STREET, ALEXANDRIA, VA, 22314, US

(73) Assignee: Sanken Electric Co., Ltd., Niiza-shi (JP)

(21) Appl. No.: 12/478,223

(22) Filed: Jun. 4, 2009

(30) Foreign Application Priority Data
Jun. 9, 2008 (JP) 2008-150825

(51) Int. Cl. H02M 3/22

(52) U.S. Cl. 363/15

(57) ABSTRACT

A power source apparatus includes a DC voltage generator (1, 2, 3) to generate a DC voltage, a plurality of voltage converters connected in parallel with one another and each having a switching element (5a/5b) to convert the DC voltage generated by the DC voltage generator into a predetermined DC voltage, a first controller 10 to generate a first control signal for controlling ON/OFF of one of the switching elements contained in the plurality of voltage converters, and a second controller 20 to control, according to the first control signal, the switching elements other than the switching element controlled by the first controller.

### BACKGROUND OF THE INVENTION

1. Field of the Invention

The present invention relates to a power source apparatus for generating a predetermined DC voltage through switching operation and a control method thereof.

2. Description of the Related Art

Switching power source apparatuses of office automation tools and consumer appliances mostly include power factor correction converters. The switching power source apparatuses are required to improve efficiency in view of environmental considerations and energy saving. An example of a power factor correction converter used for the switching power source apparatus is disclosed in Japanese Unexamined Patent Application Publication No. H05-111246. This related art employs, as a power source circuit to convert an AC input into a DC output, a capacitor-input-type converter incorporating a power factor correction circuit known as a step-up chopper.

FIG. 1 is a circuit diagram illustrating the power source apparatus (power factor correction converter) according to the related art. In FIG. 1, the power factor correction converter includes an AC power source 1, a bridge rectifier 2, a capacitor 3 acting as a normal filter, a transformer-type first inductance 4a having a primary winding Pa and a criticality detecting winding Sa, a first switching element 5a, a first diode 6a for rectification, an output capacitor 7, a switching current detecting resistor 8, and a first controller 10 for generating a first control signal used to control the first switching element 5a.

FIG. 2 is a circuit diagram illustrating the inside of the first controller 10. The first controller 10 includes a first reference voltage Vref1, a second reference voltage Vref2, a first comparator 11, a second comparator 12, a current-output-type operational amplifier 13, a multiplier 14, and a flip-flop 15.

Operation of the power factor correction converter according to the related art will be explained. The AC power source 1 outputs a sinusoidal voltage Vin, which is rectified by the bridge rectifier 2 and is supplied through the capacitor 3 to a power factor correction circuit that consists of the first inductance 4a, first switching element 5a, and first diode 6a. When the flip-flop 15 in the first controller 10 outputs the first control signal of high level from an output terminal Q thereof to a terminal Gate connected to a gate of the first switching element 5a, the first switching element 5a in the power factor correction circuit turns on and passes a current through the first inductance 4a so that the first inductance 4a accumulates energy.

A switching current Is passing through the first switching element 5a is detected by the detecting resistor 8 and is compared with a target value in the second comparator 12 of the first controller 10. If the switching current Is is equal to or larger than the target value, the second comparator 12 outputs a high-level signal to a reset terminal R of the flip-flop 15, thereby resetting the flip-flop 15. The flip-flop 15 then outputs the first control signal of low level from the output terminal Q to the terminal Gate to turn off the first switching element 5a. When the first switching element 5a turns off, the energy accumulated in the first inductance 4a and the sinusoidal voltage Vin supplied from the AC power source 1 charge the output capacitor 7 through the first diode 6a, to increase an output voltage Vout higher than the sinusoidal voltage Vin. The output voltage Vout of the output capacitor 7 is detected by resistors R4 and R5 and is compared with the first reference voltage Vref1 by the operational amplifier 13 in the first controller 10. The operational amplifier 13 outputs a result of the comparison as an error signal to the multiplier 14. The multiplier 14 multiplies a rectified waveform detected by resistors R1 and R2 by the error signal and outputs the product as a target value to the comparator 12.

Once the energy discharge of the first inductance 4a completes, the voltage of the criticality detecting winding Sa inverts and is detected by a resistor R3. The detected voltage is compared with the second reference voltage Vref2 by the first comparator 11 in the first controller 10. The first comparator 11 outputs a result of the comparison to a set terminal S of the flip-flop 15. According to the comparison result to the set terminal S, the flip-flop 15 outputs the first control signal of high level from the output terminal Q, to turn on the first switching element 5a.

The power factor correction converter according to the related art repeats the above-mentioned operation to control ON/OFF of the first switching element 5a in such a way as to keep the output voltage Vout at a predetermined value and make an input current follow an input voltage to correct a power factor.

Another related art, Japanese Unexamined Patent Application Publication No. 2006-136046, discloses a power factor correction apparatus capable of reducing current ripples. The apparatus of this related art includes a rectifier to rectify an alternating current of a commercial power source, a plurality of step-up choppers that are connected in parallel with one another and each step up and chop an output from the rectifier, a capacitor to smooth outputs from the plurality of step-up choppers and supply a smoothed output to a load, and a controller to control the step-up choppers according to input voltages and currents to the step-up choppers and an output voltage from the capacitor so that the step-up choppers may operate at different phases.

According to this related art, the plurality of step-up choppers operate at different phases and the power factor correction apparatus employ the sum of currents passed through the step-up choppers as an input current to the load, thereby reducing current ripples.

### SUMMARY OF THE INVENTION

The power factor correction circuit disclosed in the Japanese Unexamined Patent Application Publication No. 2006-136046 uses a sawtooth wave generated by a sawtooth wave generator arranged in the controller as a reference to carry out a separately excited switching operation. This is advantageous in providing two step-up choppers with a phase difference of a half period. This related art, however, conducts no zero-current or zero-voltage switching, and therefore, causes a switching loss and noise. In addition, the apparatus adopting the separately excited switching operation needs a device for generating a reference clock, such as the sawtooth wave generator, and therefore, increases the parts, size, and cost of the apparatus.

The power factor correction converter of the related art illustrated in FIG. 1 employs self-excited oscillation to control the switching element, and therefore, achieves zero-current switching that reduces a switching loss and noise. When applied to a plurality of switching elements operated at different phases, the self-excited oscillation of this related art changes frequencies depending on inductance and load conditions of the power factor correction converter, and therefore, the related art is unable to provide a plurality of switching elements with predetermined phase differences.

To solve the problems of these related arts, the present invention provides a power source apparatus that is compact, inexpensive, and capable of minimizing noise and ripples and a method of controlling the power source apparatus.

According to an aspect of the present invention, the power source apparatus includes a DC voltage generator configured to generate a DC voltage; a plurality of voltage converters connected in parallel with one another and each having a switching element configured to convert the DC voltage generated by the DC voltage generator into a predetermined DC voltage; a first controller configured to generate a first control signal for controlling ON/OFF of one of the switching elements contained in the plurality of voltage converters; and a second controller configured to control, according to the first control signal, ON/OFF of the switching elements other than the switching element controlled by the first controller.

According to another aspect of the present invention, the method controls a power source apparatus that includes a DC voltage generator to generate a DC voltage and a plurality of voltage converters connected in parallel with one another and each having a switching element to convert the DC voltage into a predetermined DC voltage. The method includes generating a first control signal for controlling ON/OFF of one of the switching elements contained in the plurality of voltage converters; detecting a phase of the first control signal; detecting an ON time of the first control signal; and according to the detected phase and ON time, generating a second control signal for separately controlling the switching elements other than the switching element controlled according to the first control signal in such a way that each of the switching elements other than the switching element controlled according to the first control signal has a different phase from the first control signal and the same ON time as the first control signal.

### BRIEF DESCRIPTION OF THE DRAWINGS

FIG. 1 is a circuit diagram illustrating a power source apparatus according to a related art;

FIG. 2 is a circuit diagram illustrating a first controller in the power source apparatus of FIG. 1;

FIG. 3 is a circuit diagram illustrating a power source apparatus according to Embodiment 1 of the present invention;

FIG. 4 is a block diagram illustrating a second controller in the power source apparatus of FIG. 3;

FIG. 5 is a circuit diagram illustrating the details of the second controller of FIG. 4;

FIG. 6 is a waveform diagram illustrating voltages and currents of the second controller of FIG. 5;

FIG. 7 is a circuit diagram illustrating a second controller of a power source apparatus according to Embodiment 2 of the present invention;

FIG. 8 is a waveform diagram illustrating voltages and currents of the second controller of FIG. 7;

FIG. 9 is a circuit diagram illustrating a second controller of a power source apparatus according to Embodiment 3 of the present invention;

FIG. 10 is a waveform diagram illustrating voltages and currents of the second controller of FIG. 9;

FIG. 11 is a waveform diagram illustrating phase differences created of the second controller of FIG. 9;

FIG. 12 is a circuit diagram illustrating a power source apparatus according to Embodiment 4 of the present invention; and

FIG. 13 is a waveform diagram illustrating voltages and currents of the power source apparatus of FIG. 12.

### DESCRIPTION OF THE PREFERRED EMBODIMENT

Power source apparatuses and methods of controlling the power source apparatuses according to embodiments of the present invention will be explained in detail with reference to the drawings.

### Embodiment 1

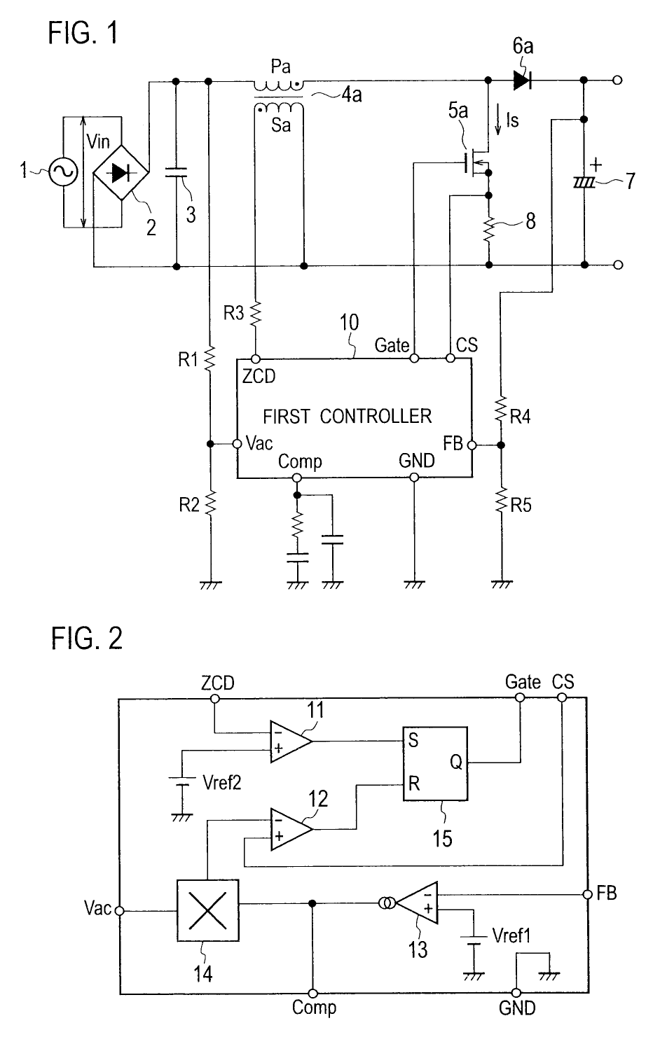

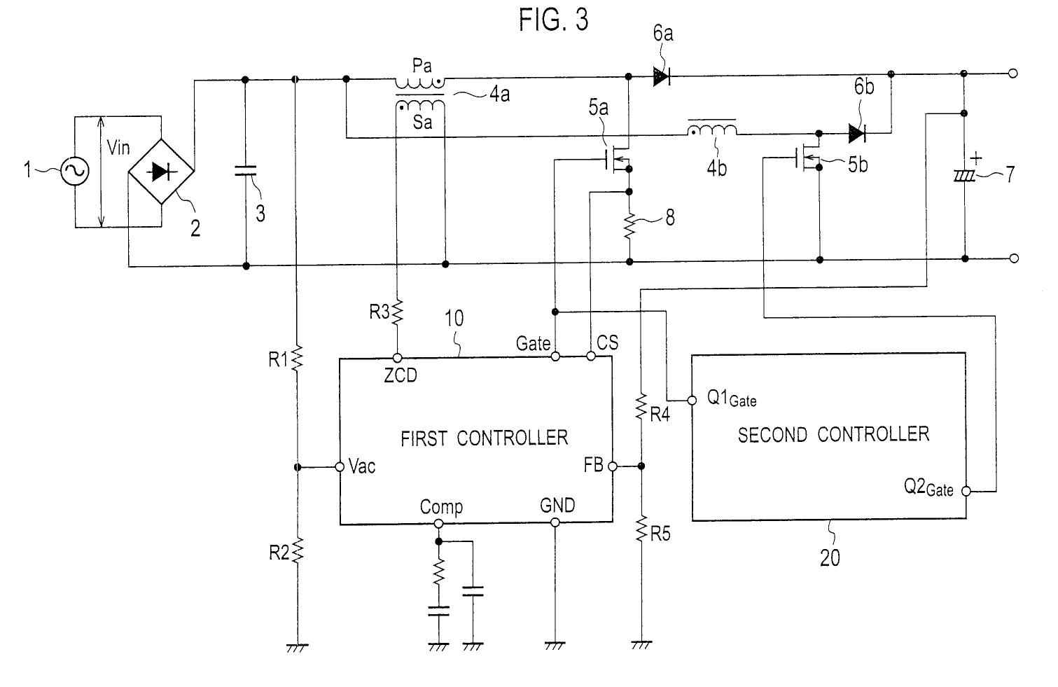

FIG. 3 is a circuit diagram illustrating a power source apparatus according to Embodiment 1 of the present invention. In FIG. 3 and other drawings illustrating the embodiments of the present invention, the same or equivalent elements as those illustrated in FIG. 1 are represented with the same reference marks as those used in FIG. 1, to omit repeated explanations. The power source apparatus of FIG. 3 according to Embodiment 1 differs from the power source apparatus of FIG. 1 according to the related art in that Embodiment 1 additionally has a power factor correction circuit including a second inductance 4b, a second switching element 5b, and a second diode 6b and a second controller 20 for generating a second control signal used to control the second switching element 5b.

In the power source apparatus of the present embodiment, an AC power source 1, a bridge rectifier 2, and a capacitor 3 is expressed in terms of the DC voltage generator stipulated in the claims and generate a pulsating DC voltage.

The power source apparatus according to the present invention includes a plurality of voltage converters connected in parallel with one another and each having a switching element configured to convert the DC voltage generated by the DC voltage generator into a predetermined DC voltage. The plurality of voltage converter corresponds to two power factor correction circuits according to the present embodiment. The power factor correction circuits are step-up-chopper-type circuits, one having a first inductance 4a, a first switching element 5a, and a first diode 6a and the other having the second inductance 4b, second switching element 5b, and second diode 6b, as illustrated in FIG. 3.

A first controller 10 of the present embodiment 1 illustrated in FIG. 3 has the same configuration as the first controller 10 of the related art illustrated in FIG. 2. The first controller 10 of the present embodiment is expressed in terms of the first controller stipulated in the claims that generates a first control signal to control ON/OFF of one of the switching elements of the plurality of voltage converters. In the present embodiment, the first controller 10 generates a first control signal to control ON/OFF of the switching element 5a in the power factor correction circuit having the first inductance 4a, first switching element 5a, and first diode 6a. The first control signal is supplied through a terminal Gate to the first switching element 5a and second controller 20.

The second controller 20 is expressed in terms of the second controller stipulated in the claims. According to the first control signal from the first controller 10, the second controller 20 controls ON/OFF of the switching elements (the switching element 5b) other than the switching element 5a controlled by the first controller 10.

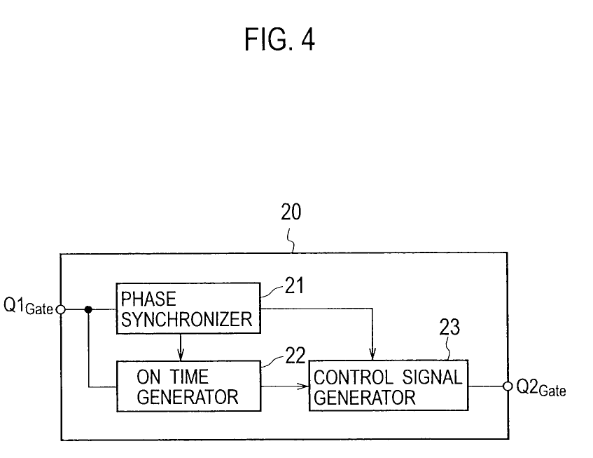

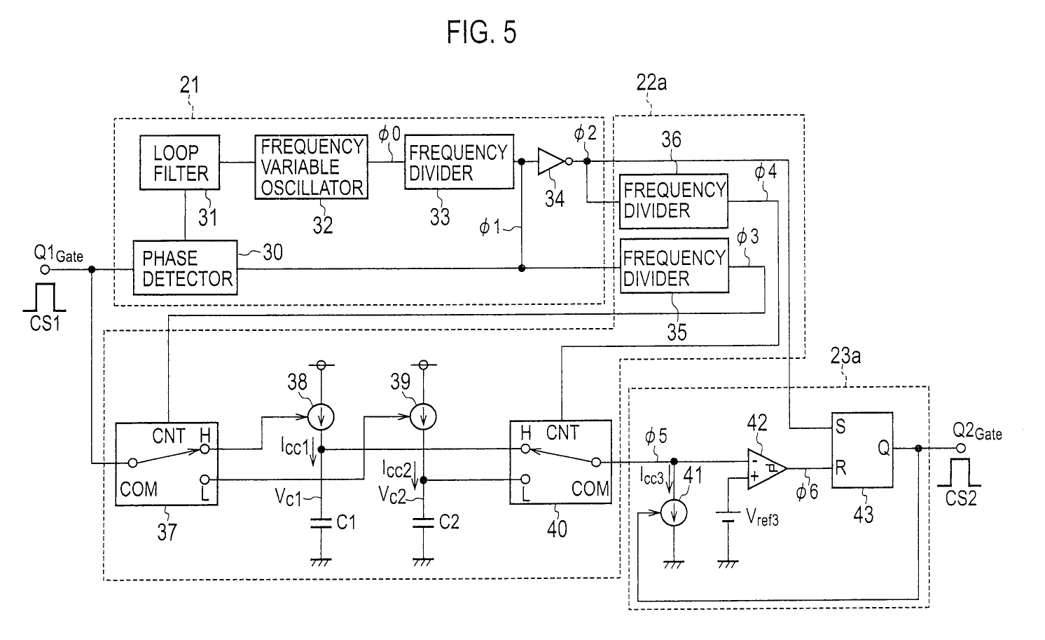

FIG. 4 is a block diagram illustrating the second controller 20 and FIG. 5 is a circuit diagram illustrating the details of the second controller 20. In FIG. 4, the second controller 20 has a phase synchronizer 21, an ON time generator 22a, and a control signal generator 23a.

The phase synchronizer 21 is expressed in terms of the phase detector stipulated in the claims and detects a phase of the first control signal generated by the first controller 10. As illustrated in FIG. 5, the phase synchronizer 21 has a phase detector 30, a loop filter 31, a frequency variable oscillator 32, a frequency divider 33, and an inverter 34.

The phase detector 30 detects a phase difference between the first control signal provided by the first controller 10 and a frequency divided signal φ1 provided by the frequency divider 33 and outputs a phase difference signal to the loop filter 31.

The loop filter 31 smoothes harmonics contained in the phase difference signal provided by the phase detector 30 and outputs the smoothed phase difference signal to the frequency variable oscillator 32.

According to the phase difference signal from the loop filter 31, the frequency variable oscillator 32 oscillates at a frequency corresponding to a level of the phase difference signal and outputs a clock signal φ0 to the frequency divider 33. According to the present embodiment, the frequency variable oscillator 32 oscillates at a frequency double the frequency of the first control signal if there is no phase difference between the first control signal and the frequency divided signal φ1.

The frequency divider 33 divides the frequency of the clock signal φ0 provided by the frequency variable oscillator 32 by N and outputs a frequency divided signal φ1 to the inverter 34 and a frequency divider 35 of the ON time generator 22a. Also, the frequency divided signal φ1 is fed back to the phase detector 30. Here, N is generally the number of the voltage converters. Accordingly, the frequency divider 33 according to the present embodiment divides the frequency of the clock signal φ0 by 2 and generates the frequency divided signal φ1. Due to the frequency variable oscillator 32 and frequency divider 33, the frequency divided signal φ1 is a pulse signal that has the same frequency as the first control signal and a duty of 50% of the first control signal.

The inverter 34 inverts the frequency divided signal φ1 provided by the frequency divider 33 and outputs an inverted signal φ2 to a frequency divider 36 in the ON time generator 22a and a terminal S of a flip-flop 43 in the control signal generator 23a.

The ON time generator 22a is expressed in terms of the ON time detector stipulated in the claims and detects an ON time of the first control signal generated by the first controller 10. As illustrated in FIG. 5, the ON time generator 22a has the frequency dividers 35 and 36, a switch 37, constant current sources 38 and 39, a switch 40, and capacitors C1 and C2.

The frequency divider 35 divides the frequency of the frequency divided signal φ1 from the frequency divider 33 of the phase synchronizer 21 by n and outputs a frequency divided signal φ3 to a terminal CNT of the switch 37. According to Embodiment 1, the frequency divider 35 halves the frequency of the frequency divided signal φ1.

The frequency divider 36 divides the frequency of the inverted signal φ2 from the inverter 34 of the phase synchronizer 31 by n and outputs a frequency divided signal φ4 to a terminal CNT of the switch 40. According to the present embodiment, the frequency divider 36 halves the frequency of the inverted signal φ2.

Each of the switches 37 and 40 connects terminals COM and H to each other if the signal to the terminal CNT is high, and if the signal is low, connects the terminals COM and L to each other. According to the present embodiment, the first control signal provided by the first controller 10 is supplied to the terminal COM of the switch 37. As mentioned above, the frequency divided signal φ3 from the frequency divider 35 is supplied to the terminal CNT of the switch 37. The terminal H of the switch 37 is connected to a control terminal of the constant current source 38 and the terminal L of the switch 37 is connected to a control terminal of the constant current source 39.

If the frequency divided signal φ3 is high, the switch 37 outputs the first control signal to the constant current source 38, to start/stop the constant current source 38 according to the first control signal. If the frequency divided signal φ3 is low, the switch 37 outputs the first control signal to the constant current source 39, to start/stop the constant current source 38 according to the first control signal.

The constant current source 38 has an input terminal connected to a power source, the control terminal connected to the terminal H of the switch 37, and an output terminal connected to the capacitor C1 and a terminal H of the switch 40. If the frequency divided signal φ3 is high and the first control signal is high, the constant current source 38 is driven by the first control signal provided through the switch 37, to supply a constant current Icc1 to the capacitor C1. The capacitor C1 is then gradually charged and outputs a terminal voltage Vc1 to the terminal H of the switch 40.

The constant current source 39 has an input terminal connected to the power source, the control terminal connected to the terminal L of the switch 37, and an output terminal connected to the capacitor C2 and a terminal L of the switch 40. If the frequency divided signal φ3 is low and the first control signal is high, the constant current source 39 is driven by the first control signal provided through the switch 37, to supply a constant current Icc2 to the capacitor C2. The capacitor C2 is then gradually charged and outputs a terminal voltage Vc2 to the terminal L of the switch 40.

According to the present embodiment, the frequency divided signal φ4 from the frequency divider 36 is supplied to the terminal CNT of the switch 40. As mentioned above, the terminal voltage Vc1 of the capacitor C1 is supplied to the terminal H of the switch 40 and the terminal voltage Vc2 of the capacitor C2 is supplied to the terminal L of the switch 40. A terminal COM of the switch 40 is connected to a negative terminal (depicted by “−”) of a comparator 42 and an input terminal of a constant current source 41.

If the frequency divided signal φ4 is high, the switch 40 supplies the terminal voltage Vc1 of the capacitor C1 as a voltage signal φ5 to the negative terminal of the comparator 42 and the input terminal of the constant current source 41. If the frequency divided signal φ4 is low, the switch 40 supplies the terminal voltage Vc2 of the capacitor C2 as the voltage signal φ5 to the negative terminal of the comparator 42 and the input terminal of the constant current source 41.

The control signal generator 23a is expressed in terms of the control signal generator stipulated in the claims. According to the phase detected by the phase synchronizer 21 and the ON time detected by the ON time generator 22a, the control signal generator 23a generates the second control signal to control each switching element (the switching element 5b of the present embodiment) other than the switching element 5a controlled by the first controller 10.

As illustrated in FIG. 5, the control signal generator 23a has the constant current source 41, comparator 42, and flip-flop 43.

The constant current source 41 has a control terminal connected to a terminal Q of the flip-flop 43, the input terminal connected to the negative input terminal of the comparator 42 and the terminal COM of the switch 40 in the ON time generator 22a, and an output terminal connected to the ground. The constant current source 41 is driven when the second control signal from the flip-flop 43 is high, to supply a constant current Icc3 to the ground.

The comparator 42 has a positive input terminal (depicted by “+”) to receive a reference voltage Vref3 and the negative input terminal connected to the input terminal of the constant current source 41 and the terminal COM of the switch 40 in the ON time generator 22a. The comparator 42 outputs a comparator signal φ6 of high level if the reference voltage Vref3 is larger than the voltage signal φ5, and if the reference voltage Vref3 is smaller than the voltage signal φ5, decreases the comparator signal φ6 to low level. According to the present embodiment, the comparator 42 has a hysteresis with respect to the input signal to the positive terminal thereof.

The flip-flop 43 has the terminal S to receive the inverted signal φ2, a terminal R to receive the comparator signal φ6, and the terminal Q to output the second control signal. The second control signal from the flip-flop 43 controls ON/OFF of the second switching element 5b and is supplied to the control terminal of the constant current source 41. According to the present embodiment, the flip-flop 43 is a reset-preferential-type flip-flop that makes the second control signal, i.e., the output signal from the terminal Q low if the input signals to the terminals S and R each are high. The constant currents Icc1, Icc2, and Icc3 provided by the constant current sources 38, 39, and 41 are equal to one another.

Operation of the power source apparatus according to the present embodiment will be explained. In the DC voltage generator, the AC power source 1 outputs a sinusoidal voltage Vin and the bridge rectifier 2 rectifies the voltage Vin into a pulsating voltage. This is expressed in terms of generating a DC voltage stipulated in the claims. The capacitor 3 is a normal filter capacitor to absorb harmonic switching noise.

The generated pulsating DC voltage is supplied to the plurality of voltage converters that are connected in parallel with one another and each have a switching element for converting the pulsating DC voltage into a predetermined DC voltage. This procedure is expressed in terms of converting the DC voltage into a first DC voltage stipulated in the According to the present embodiment, the voltage converters are the power factor correction circuit having the first inductance 4a, first switching element 5a, and first diode 6a and the power factor correction circuit having the second inductance 4b, second switching element 5b, and second diode 6b.

The first controller 10 generates the first control signal for controlling ON/OFF of the switching element 5a and supplies the first control signal through the terminal Gate to the first switching element 5a. This is expressed in terms of generating a first control signal stipulated in the claims. At this time, the first controller 10 supplies the first control signal to a gate Q1Gate of the second controller 20. Operation of the first controller 10 is the same as that of the first controller 10 of the related art, and therefore, will not be explained.

Operation of the second controller 20 will be explained. The second controller 20 controls each (the switching element 5b of the present embodiment) of the switching elements other than the switching element 5a controlled by the first controller 10 in such a way that the switching element other than the switching element 5a has a different phase from the first control signal and the same ON time as the first control signal.

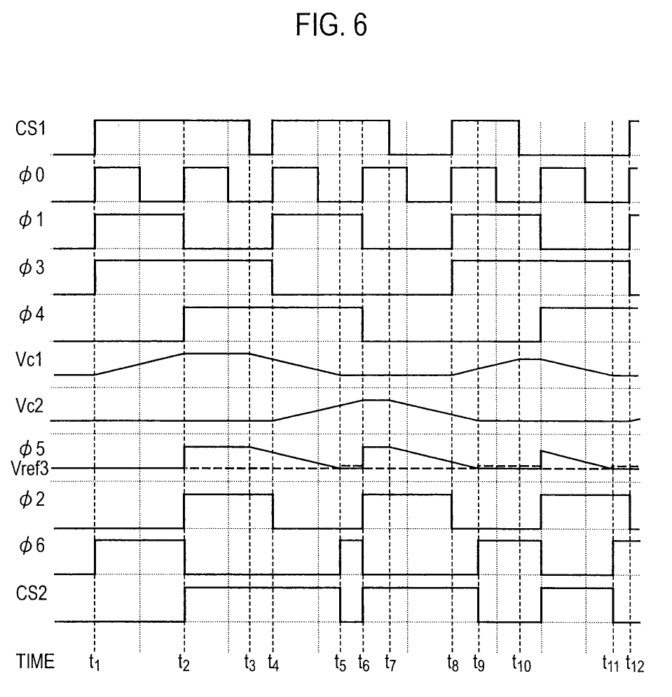

FIG. 6 is a waveform diagram illustrating voltages and currents in the second controller 20. In FIG. 6, CS1 is the first control signal generated by the first controller 10. The first control signal CS1 is supplied to the phase synchronizer 21 and ON time generator 22a.

The phase synchronizer 21 detects a phase of the first control signal CS1 generated by the first controller 10. This procedure is expressed in terms of detecting a phase of the first control signal stipulated in the claims. In a period from t1 to t2, the first control signal CS1 is high. At time t1, the phase detector 30 outputs a phase difference signal, which is passed through the loop filter 31 to the frequency variable oscillator 32. The frequency variable oscillator 32 outputs the clock signal φ0 at a frequency twice as large as the frequency of the first control signal CS1. The frequency divider 33 halves the frequency of the clock signal φ0 and outputs the frequency divided signal φ1 of high level.

The frequency divider 35 halves the frequency of the frequency divided signal φ and outputs the frequency divided signal φ3 of high level to the terminal CNT of the switch 37. This connects the terminal COM of the switch 37 to the terminal H thereof, so that the first control signal CS1 of high level drives the constant current source 38, which supplies the constant current to the capacitor C1 to charge the capacitor C1.

At this time, the inverter 34 inverts the frequency divided signal φ1 provided by the frequency divider 33 and outputs the inverted signal φ2 of low level. The frequency divider 36 halves the frequency of the inverted signal φ2 and outputs the frequency divided signal φ4 of low level to the terminal CNT of the switch 40. This connects the terminal COM of the switch 40 to the terminal L thereof, so that the voltage signal φ5 (terminal voltage Vc2) of low level is supplied to the negative terminal of the comparator 42, which provides the terminal R of the flip-flop 43 with the comparator signal φ6 of high level. Then, the flip-flop 43 is reset to output the second control signal CS2 of low level from the terminal Q.

In a period from t2 to t3, the first control signal CS1 keeps high level. At time t2 when the first control signal CS1 passes a half period, the frequency divided signal φ1 becomes low and the inverted signal φ2 becomes high.

The frequency divided signal φ4 becomes high, the switch 40 connects the terminal COM to the terminal H, and the voltage signal φ5 (terminal voltage Vc1) higher than the reference voltage Vref3 is supplied to the negative terminal of the comparator 42. The comparator 42 outputs the comparator signal φ6 of low level to the terminal R of the flip-flop 43. The flip-flop 43 is set to output the second control signal CS2 of high level from the terminal Q. The second control signal CS2 is passed through a terminal Q2Gate to the second switching element 5b to turn on the second switching element 5b and drive the constant current source 41. In the period from t2 to t3, the capacitor C1 is charged by the constant current source 38, and at the same time, is discharged by the constant current source 41, to keep the voltage signal φ5 (terminal voltage Vc1) at a constant level.

In a period from t1 to t3, the first control signal CS1 keeps high level. The ON time generator 22a detects an ON time (i.e., from t1 to t3) of the first control signal CS1 generated by the first controller 10. This is expressed in terms of detecting an ON time of the first control signal stipulated in the claims. The ON time generator 22a charges the capacitor C1 while the first control signal CS1 is ON, thereby detecting the ON time.

In a period from t3 to t4, the first control signal CS1 is low. At time t3, the constant current source 38 is stopped and the capacitor C1 is only discharged by the constant current source 41. As results, the voltage signal φ5 (terminal voltage Vc1) gradually decreases. The comparator 42, however, keeps the comparator signal φ6 at low level until the voltage Vc1 drops below the reference voltage Vref3. Accordingly, the flip-flop 43 keeps the set state and continuously outputs the second control signal CS2 of high level.

In a period from t4 to t5, the first control signal CS1 is high again. At time t4 when the first control signal CS1 passes one period, the frequency divided signal φ3 becomes low and the switch 37 connects the terminals COM and L to each other. The first control signal CS1 drives through the switch 37 the constant current source 39, which supplies the constant current to the capacitor C2 to charge the capacitor C2. The voltage signal φ5 (terminal voltage Vc1) is higher than the reference voltage Vref3, and therefore, the flip-flop 43 keeps the set state to maintain the second control signal CS2 at high level.

According to the detected phase and ON time, the control signal generator 23a generates the second control signal CS2 to control each (the switching element 5b of the present embodiment) of the switching elements other than the switching element 5a controlled by the first control signal CS1 in such a way that the switching element other than the switching element 5a has a different phase from the first control signal CS1 and the same ON time as the first control signal CS1. This is expressed in terms of generating a second control signal stipulated in the claims.

More precisely, at time t2 when the inverted signal φ2 rises, the control signal generator 23a raises the second control signal CS2, to provide a predetermined phase difference (180°) between the first and second control signals CS1 and CS2. When raising the second control signal CS2, the control signal generator 23a drives the constant current source 41 to keep the second control signal CS2 at high level during a period from t2 to t5 in which the capacitor C1 discharges. This provides the second control signal CS2 with the same ON time as the first control signal CS1. This is achievable because the charging and discharging of the capacitor C1 are carried out with the same amount of current, and therefore, a charging time of the capacitor C1 (ON time of the first control signal CS1) is equal to a discharging time of the capacitor C1 (ON time of the second control signal CS2).

In a period from t5 to t6, the first control signal CS1 maintains the high level. At time t5, the capacitor C1 discharges and the voltage signal φ5 (terminal voltage Vc1) decreases below the reference voltage Vref3. Then, the comparator 42 outputs the comparator signal φ6 of high level to the terminal R of the flip-flop 43, to reset the flip-flop 43. The flip-flop 43 outputs the second control signal CS2 of low level to turn off the second switching element 5b.

In a period from t6 to t7, the first control signal CS1 maintains the high level. The frequency divided signal φ1 becomes low and the inverted signal φ2 becomes high. The frequency divided signal φ4 becomes low, and therefore, the switch 40 connects the terminals COM and L to each other to guide the voltage signal φ5 (terminal voltage Vc2) higher than the reference voltage Vref3 to the negative terminal of the comparator 42. The comparator 42 outputs the comparator signal φ6 of low level to the terminal R of the flip-flop 43, so that the flip-flop 43 is set to output the second control signal CS2 of high level. The second control signal CS2 is passed through the terminal Q2Gate to the second switching element 5b to turn on the second switching element 5b and drive the constant current source 41. In the period from t6 to t7, the capacitor C2 maintains the voltage signal φ5 (terminal voltage Vc2) at a predetermined level because the capacitor C2 is simultaneously discharged by the constant current source 39 and charged by the constant current source 41.

In a period from t7 to t8, the first control signal CS1 is low. At time t7, the constant current source 39 is stopped and the capacitor C2 is only discharged by the constant current source 41, to gradually decrease the voltage signal φ5 (terminal voltage Vc2). Without regard to this, the comparator 42 maintains the comparator signal φ6 at low level until the voltage Vc2 decreases below the reference voltage Vref3. Accordingly, the flip-flop 43 keeps the set state and continuously outputs the second control signal CS2 of high level.

In a period from t8 to t9, the first control signal CS1 is high. At time t8, the frequency divided signal φ3 becomes high and the switch 37 connects the terminals COM and H to each other. The first control signal CS1 drives through the switch 37 the constant current source 38. The constant current source 38 supplies the constant current to the capacitor C1 to again charge the capacitor C1. The voltage signal φ5 (terminal voltage Vc2) is higher than the reference voltage Vref3, so that the flip-flop 43 maintains the set state and continuously outputs the second control signal CS2 of high level.

The ON time generator 22a charges the capacitor C2 in a period from t4 to t7 and detects the ON time of the first control signal CS1. The control signal generator 23a provides the predetermined phase difference (180°) between the first and second controls signals CS1 and CS2, drives the constant current source 41 at the timing when the second control signal CS2 becomes high, and maintains the second control signal CS2 at high level in the period in which the capacitor C2 is discharged (from t6 to t9). As a result, the second control signal CS2 is provided with the same ON time as the first control signal CS1.

It is considered, therefore, that the second controller 20 has a time constant circuit to store states of the first control signal CS1 generated by the first controller 10. The time constant circuit includes the constant current sources 38, 39, and 41 and the capacitors C1 and C2. According to the present embodiment, a phase difference between the first and second control signals CS1 and CS2 is 180°. The phase difference may not be limited to 180°.

In a period from t9 to t10, the first control signal CS1 is high. At time t9, the capacitor C2 discharges, the voltage signal φ5 (terminal voltage Vc2) becomes lower than the reference voltage Vref3, and the comparator 42 outputs the comparator signal φ6 of high level to the terminal R of the flip-flop 43 to reset the flip-flop 43. The flip-flop 43, therefore, outputs the second control signal CS2 of low level to turn off the second switching element 5b.

In a period from t10 to t11, the first control signal CS1 is low. At time t10, the constant current source 38 stops. The frequency divided signal φ4 is low, the switch 40 connects the terminal COM and L to each other, and the terminal voltage Vc1 maintains a constant level. When the frequency divided signal φ4 becomes high, the voltage signal φ5 (terminal voltage Vc1) becomes higher than the reference voltage Vref3 and the inverted signal φ2 becomes high. As a result, the flip-flop 43 is set to output the second control signal CS2 of high level.

In a period from t11 to t12, the first control signal CS1 is low. At time t11, the capacitor C1 discharges, the voltage signal φ5 (terminal voltage Vc1) becomes lower than the reference voltage Vref3, and the comparator 42 outputs the comparator signal φ6 of high level to the terminal R of the flip-flop 43. At this time, the inverted signal φ2 is high. However, the flip-flop 43 is of the reset preferential type, and therefore, outputs the second control signal CS2 of low level to turn off the second switching element 5b.

As mentioned above, the power source apparatus and the method of controlling the power source apparatus according to the present embodiment minimize noise and ripples and reduce the size and cost of the apparatus. According to the power source apparatus of the present embodiment, the step-up circuits (switching elements) carry out power factor correction operations at different phases (with a phase difference of, for example, 360°/N) and the same ON time, to apply the sum of currents passing through the step-up circuits as an input current to a load. This configuration minimizes noise and current ripples.

The second controller 20 has the time constant circuit to store states of the first control signal. The inverted signal φ2 is provided with a delay of a half period (180°) from the first control signal CS1, the inverted signal φ2 is used as a trigger to change the second control signal CS2 to high level, the capacitor C1 or C2 is charged in an ON time of the first control signal CS1, the terminal voltages Vc1 and Vc2 of the capacitors C1 and C2 are switched from one to another to generate the voltage signal φ5, and the voltage signal φ5 is used as a trigger to change the second control signal CS2 to low level. Consequently, the second control signal CS2 has a phase difference of a half period (180°) relative to the first control signal CS1 and the same ON time as the first control signal CS1.

The power source apparatus according to the present embodiment self oscillates to eliminate a device for generating a reference clock. This reduces the number of parts, the size, and the cost of the apparatus. Due to the self oscillation, the power source apparatus of Embodiment 1 realizes zero-current switching to minimize a switching loss and noise.

### Embodiment 2

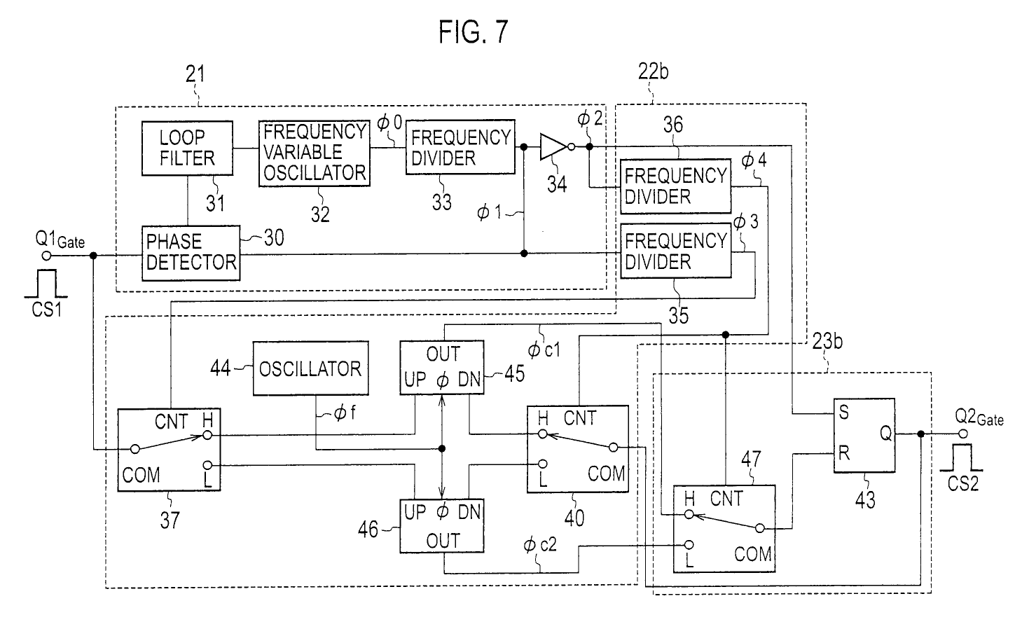

FIG. 7 is a circuit diagram illustrating the details of a second controller 20 in a power source apparatus according to Embodiment 2 of the present invention. The second controller 20 has a phase synchronizer 21, an ON time generator 22b, and a control signal generator 23b. The phase synchronizer 21 is the same as that of Embodiment 1, and therefore, will not be explained again.

The ON time generator 22b has frequency dividers 35 and 36, switches 37 and 40, an oscillator 44, and counters 45 and 46. The frequency divider 35 is the same as that of Embodiment 1. The frequency divider 36 divides the frequency of an inverted signal φ2 provided by an inverter 34 in the phase synchronizer 21 by n and generates a frequency divided signal φ4, which is supplied to a terminal CNT of the switch 40 and a terminal CNT of a switch 47 in the control signal generator 23b.

Each of the counters 45 and 46 achieves an adding mode if a voltage at a terminal UP is high. In the adding mode, the counter adds up pulses of a pulse signal φf supplied from the oscillator 44 to a terminal φ. When a voltage at a terminal DN is high, the counter achieves a subtracting mode in which the counter subtracts pulses of the pulse signal φf supplied to the terminal φ. If the number of pulses stored in the counter decreases to zero or below, the counter outputs a counter signal φc1 (φc2) of high level from a terminal OUT. If the voltage at the terminal UP and the voltage at the terminal DN each are high or low, the counter achieves an insensitive mode to hold the state at the moment and outputs the counter signal φc1 (φc2).

According to the present embodiment, a first controller 10 outputs a first control signal to a terminal COM of the switch 37. Like Embodiment 1, the frequency divider 35 outputs a frequency divided signal φ3 to a terminal CNT of the switch 37. The switch 37 has a terminal H connected to the terminal UP of the counter 45 and a terminal L connected to the terminal UP of the counter 46.

If the frequency divided signal φ3 is high, the switch 37 outputs the first control signal to the terminal UP of the counter 45, to turn on/off the adding mode of the counter 45 according to the first control signal. If the frequency divided signal φ3 is low, the switch 37 outputs the first control signal to the terminal UP of the counter 46, to turn on/off the adding mode of the counter 46 according to the first control signal.

The frequency divided signal φ4 from the frequency divider 36 is supplied to the terminal CNT of the switch 40. The switch 40 has a terminal H connected to the terminal DN of the counter 45, a terminal L connected to the terminal DN of the counter 46, and a terminal COM connected to a terminal Q of a flip-flop 43.

If the frequency divided signal φ4 is high, the switch 40 outputs a second control signal CS2 to the terminal DN of the counter 45 to turn on/off the subtracting mode of the counter 45 according to the second control signal CS2. If the frequency divided signal φ4 is low, the switch 40 outputs the second control signal CS2 to the terminal DN of the counter 46, to turn on/off the subtracting mode of the counter 46.

According to Embodiment 2, the frequency divider 36 halves the frequency of the inverted signal φ2. The oscillator 44 has an input terminal connected to a power source (not illustrated) and outputs the pulse signal φf having a fixed frequency to the terminals φ of the counters 45 and 46. The frequency of the pulse signal φf is sufficiently higher, for example, twenty times higher than the switching frequency of each power factor correction inverter (i.e., the frequency of the first and second control signals CS1 and CS2).

The counter 45 has the terminal φ connected to the oscillator 44 and the terminal φ of the counter 46, the terminal UP connected to the terminal H of the switch 37, the terminal DN connected to the terminal H of the switch 40, and the terminal OUT connected to the terminal H of the switch 47 in the control signal generator 23b.

The counter 46 has the terminal φ connected to the oscillator 44 and the terminal φ of the counter 45, the terminal UP connected to the terminal L of the switch 37, the terminal DN connected to the terminal L of the switch 40, and the terminal OUT connected to the terminal L of the switch 47 in the control signal generator 23b.

The control signal generator 23b has the switch 47 and flip-flop 43.

Like the switches 37 and 40, the switch 47 connects terminals COM and H to each other if the signal to the terminal CNT is high, and if the signal to the terminal CNT is low, connects the terminals COM and L to each other. The switch 47 has the terminal CNT to receive the frequency divided signal φ4 from the frequency divider 36, the terminal L connected to the terminal OUT of the counter 46 in the ON time generator 22b, the terminal H connected to the terminal OUT of the counter 45 in the ON time generator 22b, and the terminal COM connected to a terminal R of the flip-flop 43.

Like that of Embodiment 1, the flip-flop 43 is of a reset preferential type and has a terminal S to receive the inverted signal φ2 from the inverter 34 of the phase synchronizer 21 and the terminal R connected to the terminal COM of the switch 47. The flip-flop 43 generates the second control signal CS2 and outputs the same from a terminal Q to a second switching element 5b and the terminal COM of the switch 40 in the ON time generator 22b.

The remaining part other than the second controller 20 of Embodiment 2 is the same as Embodiment 1, and therefore, the same part will not be explained.

Operation of the power source apparatus according to the present embodiment will be explained. Elements of the present embodiment except the second controller 20 operate like those of Embodiment 1. The second controller 20 of the present embodiment includes parts that are specific to the present embodiment, and therefore, differently operates from the second controller 20 of Embodiment 1.

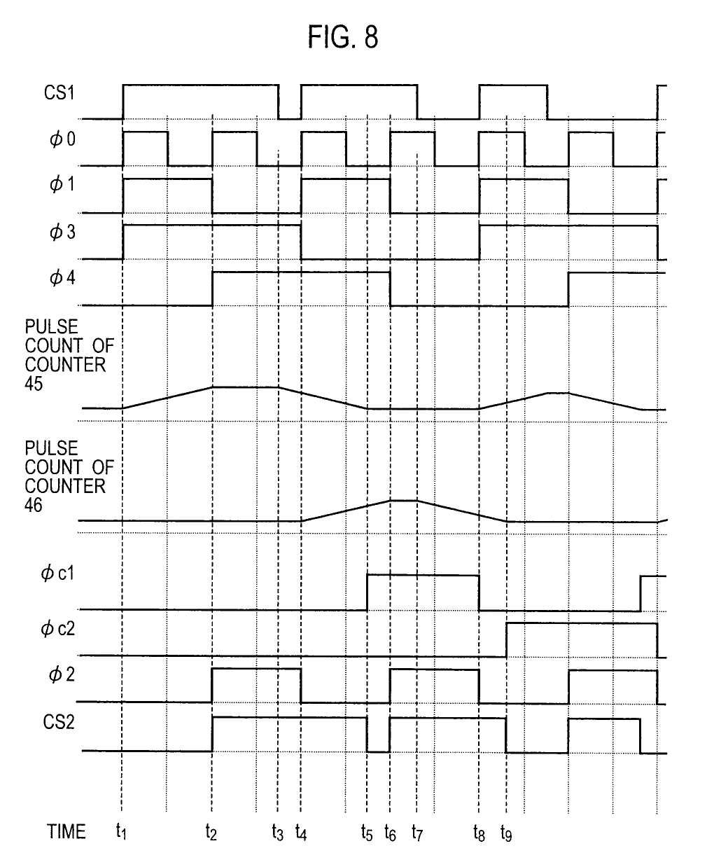

FIG. 8 is a waveform diagram illustrating voltages and currents in the second controller 20 of the present embodiment. The first control signal CS1 generated by the first controller 10 is supplied to the phase synchronizer 21 and ON time generator 22b.

Operation of the phase synchronizer 21 is the same as that of Embodiment 1, and therefore, will not be explained. In a period from t1 to t2, the first control signal CS1 is high. At time t1, the phase synchronizer 21 outputs the frequency divided signal φ1 of high level and the inverted signal φ2 of low level, like Embodiment 1.

The frequency divider 35 outputs a frequency divided signal φ3 of high level to connect the terminals COM and H of the switch 37 to each other. The first control signal CS1 of high level is applied through the switch 37 to the terminal UP of the counter 45 to put the counter 45 in the adding mode and make the counter signal φc1 low. The frequency divider 36 outputs a frequency divided signal φ4 of low level to connect the terminals COM and L of each of the switches 40 and 47 to each other. The flip-flop 43 outputs the second control signal CS2 of low level to the switching element 5b, and through the switch 40, to the terminal DN of the counter 46. The counter signal φc2 is supplied through the switch 47 to the terminal R of the flip-flop 43.

In a period from t2 to t3, the first control signal CS1 is high. At time t2 when the first control signal CS1 passes a half period, the frequency divided signal φ1 becomes low and the inverted signal φ2 becomes high.

The frequency divided signal φ4 becomes high and each of the switches 40 and 47 connects the terminals COM and H to each other. Due to this, the flip-flop 43 outputs the second control signal CS2 to the switching element 5b, and through the switch 40, to the terminal DN of the counter 45. The counter 45 outputs the counter signal φc1 through the switch 47 to the terminal R of the flip-flop 43 to set the flip-flop 43. The flip-flop 43 then outputs the second control signal CS2 of high level. At this time, the counter 45 is high at each of the terminals UP and DN, and therefore, starts the insensitive mode to keep a pulse count and output the counter signal φc1 of low level.

In a period from t1 to t3, the first control signal CS1 is high. The ON time generator 22b detects an ON time (i.e., the period from t1 to t3) of the first control signal CS1 generated by the first controller 10. This procedure is expressed in terms of detecting an ON time of the first control signal stipulated in the claims. While the first control signal CS1 is ON, the ON time generator 22a puts the counter 45 in the adding mode to add up the number of pulses to detect the ON time.

In a period from t3 to t4, the first control signal CS1 is low. At time t3, the terminal UP of the counter 45 becomes low and the terminal DN thereof is high, to start the subtracting mode that gradually decreases the number of pulses stored therein. The counter 45, however, keeps the counter signal φc1 at low level until the pulse count becomes zero. Accordingly, the flip-flop 43 keeps the set state and continuously outputs the second control signal CS2 of high level.

In a period from t4 to t5, the first control signal CS1 is high again. At time t4 when the first control signal CS1 passes one period, the frequency divided signal φ3 becomes low to cause the switch 37 to connect the terminals COM and L to each other. The first control signal CS1 is passed through the switch 37 to make the terminal UP of the counter 46 high. The counter 46 then starts the adding mode. The counter 45 is in the subtracting mode but it outputs the counter signal φc1 of low level to the terminal R of the flip-flop 43 until the pulse count stored in the counter 45 becomes zero. Accordingly, the flip-flop 43 maintains the second control signal CS2 at high level.

According to the detected phase and ON time, the control signal generator 23b generates the second control signal CS2 to control each (the switching element 5b of the present embodiment) of the switching elements other than the switching element 5a in such a way that the switching element other than the switching element 5a has a different phase from the first control signal CS1 and the same ON time as the first control signal CS1. This is expressed in terms of a second control signal stipulated in the claims.

More precisely, at time t2 when the inverted signal φ2 rises, the control signal generator 23b raises the second control signal CS2 to high level, to provide a predetermined phase difference (180°) between the first and second control signals CS1 and CS2. When raising the second control signal CS2 to high level, the control signal generator 23b raises the terminal DN of the counter 45 to high level to establish the subtracting mode so that the second control signal CS2 is kept at high level in a period from t2 to t5 during which the pulse count stored in the counter 45 becomes zero. This provides the second control signal CS2 with the same ON time as the first control signal CS1.

This is achievable because the terminal φ of the counter 45 always receives the pulse signal φf of a fixed frequency so that the time in which the counter 45 is in the adding mode (the ON time of the first control signal CS1) is equal to the time in which the counter 45 is in the subtracting mode (the ON time of the second control signal CS2).

In a period from t5 to t6, the first control signal CS1 is high. At time t5, the counter 45 achieves the subtracting mode in which the pulse count decreases below zero and outputs the counter signal φc1 of high level to the terminal R of the flip-flop 43. The flip-flop 43 is reset to output the second control signal CS2 of low level to turn off the second switching element 5b.

In a period from t6 to t7, the first control signal CS1 is high. The frequency divided signal φ1 becomes low and the inverted signal φ2 becomes high. The frequency divided signal φ4 becomes low and the switches 40 and 47 each connect the terminals COM and L to each other. The counter 46 outputs the counter signal φc2 of low level to the terminal R of the flip-flop 43. The flip-flop 43 is set to output the second control signal CS2 of high level, which is passed through a terminal Q2Gate to turn on the second switching element 5b. At the same time, the second control signal CS2 is passed through the switch 40 to the terminal DN of the counter 46 to put the counter 46 in the insensitive mode.

In a period from t7 to t8, the first control signal CS1 is low. At time t7, the terminal UP of the counter 46 becomes low to put the counter 46 in the subtracting mode. However, the counter 46 outputs the counter signal φc2 of low level to the terminal R of the flip-flop 43 until the pulse count stored therein decreases below zero. The flip-flop 43, therefore, maintains the set state and continuously outputs the second control signal CS2 of high level.

In a period from t8 to t9, the first control signal CS1 is high. At time t8, the frequency divided signal φ3 becomes high and the switch 37 connects the terminals COM and H to each other. The first control signal CS1 is passed through the switch 37 to the terminal UP of the counter 45 to put the counter 45 in the adding mode. The counter 46 is in the subtracting mode to output the counter signal φc2 of low level to the terminal R of the flip-flop 43. The flip-flop 43 maintains the set state and continuously outputs the second control signal CS2 of high level.

The ON time generator 22b puts the counter 46 in the adding mode in a period from t4 to t7, to add up the number of pulses and detect an ON time of the first control signal CS1. The control signal generator 23b provides the predetermined phase difference (180°) between the first and second control signals CS1 and CS2, and at the timing when raising the second control signal CS2 to high, makes the terminal DN of the counter 46 high to start the subtracting mode. The control signal generator 23b maintains the second control signal CS2 at high level in a period from t6 to t9 during which the pulse count of the counter 46 decreases to zero, thereby providing the second control signal CS2 with the same ON time as the first control signal CS1.

The second controller 20 is considered to have a counter to store a state of the first control signal CS1 generated by the first controller 10. Here, the counter means the counters 45 and 46. According to the present embodiment, a phase difference between the first and second control signals is 180°. Any other phase difference value is adoptable.

Operation of the second controller 20 according to the present embodiment after time t9 is the same as that of Embodiment 1 except that the operation of the time constant circuit of Embodiment 1 is carried out by the counter.

As mentioned above, the power source apparatus and the method of controlling the power source apparatus according to the present embodiment employ the counter in the second controller 20 instead of the time constant circuit of Embodiment 1, to minimize noise and ripples and reduce the size and cost of the apparatus, like Embodiment 1.

The second controller 20 of the present embodiment generates the inverted signal φ2 that is behind the first control signal CS1 by a half period (180°), uses the inverted signal φ2 as a trigger to change the second control signal CS2 to high level, adds up the number of pulses in the counter 45 or 46 according to an ON time of the first control signal CS1, and uses the completion of pulse subtraction of the counter as a trigger to change the second control signal CS2 to low level. As results, the second control signal CS2 has a phase difference of a half period (180°) with respect to the first control signal CS1 and the same ON time as the first control signal CS1.

### Embodiment 3

A power source apparatus according to Embodiment 3 will be explained. The power source apparatus of Embodiment 3 differs from that of Embodiment 1 in that it has three power factor correction circuits including switching elements and that it employs a second controller 20 whose configuration is different from that of Embodiment 1. Although a general view illustrating the power source apparatus of Embodiment 3 is not provided, it includes, in addition to the power source apparatus of one of Embodiments 1 and 2, a power factor correction circuit including a third switching element and connected in parallel with the other power factor correction circuits. Namely, the power source apparatus of Embodiment 3 employs three power factor correction circuits that operate at phase differences of 120 degrees.

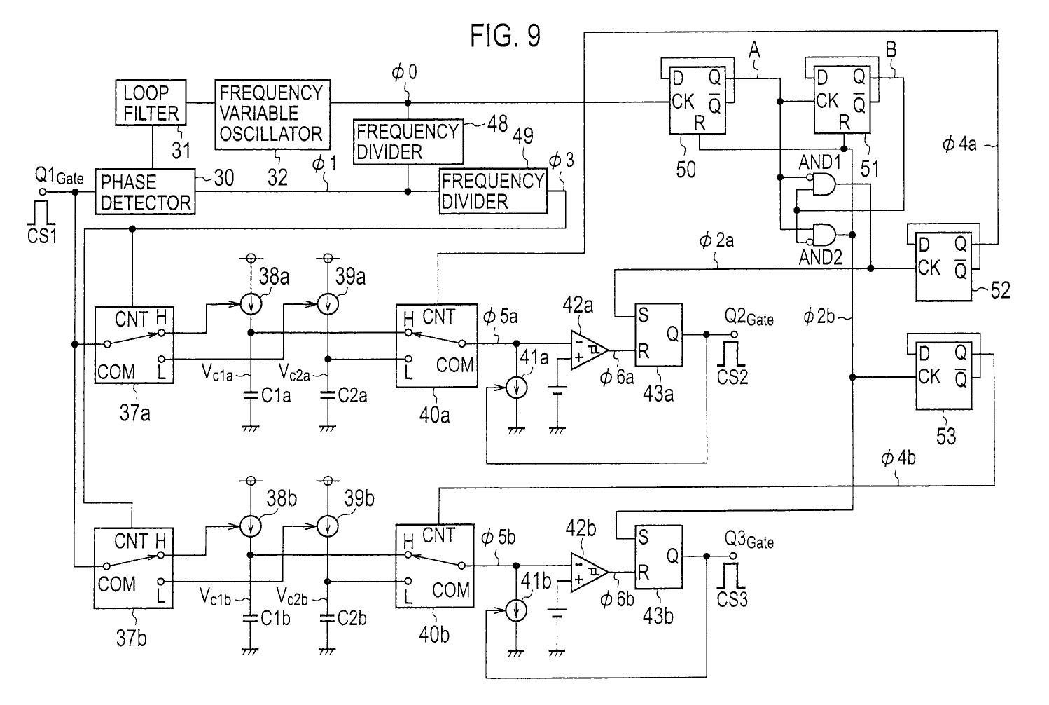

FIG. 9 is a circuit diagram illustrating the details of the second controller 20 in the power source apparatus according to the present embodiment. The second controller 20 receives a first control signal CS1 generated by a first controller 10, and according to the first control signal CS1, controls ON/OFF of switching elements (two switching elements of the present embodiment) other than a switching element controlled by the first controller 10.

Differences between the second controller 20 of Embodiment 1 illustrated in FIG. 5 and the second controller 20 of the present embodiment illustrated in FIG. 9 will be explained. The second controller 20 of the present embodiment illustrated in FIG. 9 has two time constant circuits to store a state of the first control signal. In addition, the second controller 20 has two circuits each corresponding to the control signal generator 23a of Embodiment 1, to generate second and third control signals CS2 and CS3.

If there is no phase difference between the first control signal CS1 and a frequency divided signal φ1, a frequency variable oscillator 32 oscillates at a frequency three times larger than the frequency of the first control signal CS1 and outputs a clock signal φ0 to a frequency divider 48 and a terminal CK of a D-type flip-flop 50.

The frequency divider 48 divides the frequency of the clock signal φ0 from the frequency variable oscillator 32 by 3, outputs a frequency divided signal φ1 to a frequency divider 49, and feeds back the signal φ1 to a phase detector 30. With the frequency variable oscillator 32 and frequency divider 48, the frequency divided signal φ1 has the same frequency as the first control signal CS1 and a pulse waveform whose duty is 50% of the first control signal CS1.

The frequency divider 49 halves the frequency of the frequency divided signal φ1 from the frequency divider 48 and outputs a frequency divided signal φ3 to terminals CNT of switches 37a and 37b.

Each of D-type flip-flops 50, 51, 52, and 53 outputs from a terminal Q thereof a value at a terminal D thereof when a waveform supplied to a terminal CK thereof rises and keeps the same value until the next rise of the waveform supplied to the terminal CK. If a high-level signal is supplied to a terminal R, the D-type flip-flop outputs from the terminal Q a low-level signal.

Operation of Embodiment 3 will be explained. A basic operation of Embodiment 3 is the same as that of Embodiment 1, and therefore, only operation specific to the present embodiment will be explained. The second controller 20 controls the switching elements (two switching elements according to the present embodiment) other than the switching element 5a controlled by the first controller 10 in such a way that each of the switching elements other than the switching element 5a has a different phase (at a phase difference of 120° as to the present embodiment) from the first control signal CS1 generated by the first controller and the same ON time as the first control signal CS1.

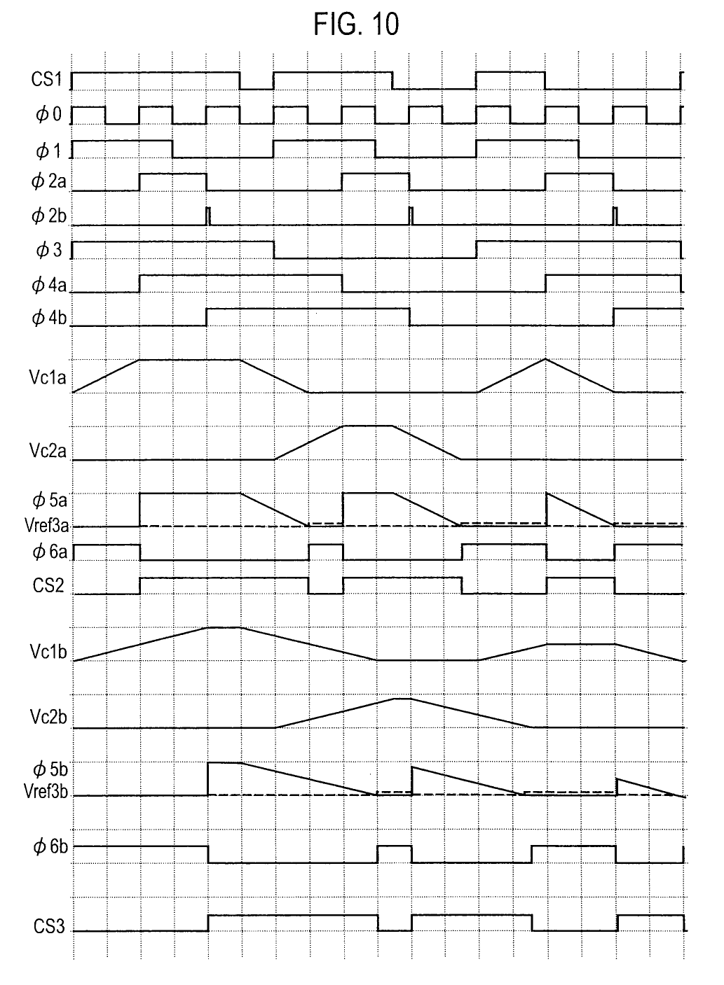

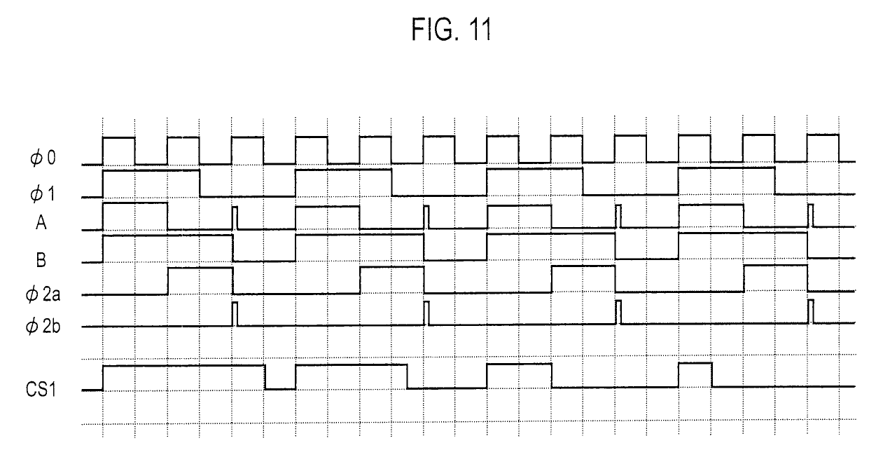

FIG. 10 is a waveform diagram illustrating voltages and currents in the second control circuit 20 of the present embodiment. As illustrated in FIG. 10, the second control signal CS2 has a phase delay of 120° from the first control signal CS1 and the same ON time as the first control signal CS1. A third control signal CS3 has a phase delay of 120° from the second control signal CS2 and the same ON time as the second control signal CS2.

FIG. 11 is a waveform diagram illustrating the creation of phase differences in the second controller 20. With reference to FIG. 11, an operation of creating a phase difference of 120° will be explained.

The frequency variable oscillator 32 outputs the clock signal φ0 whose frequency is three times as large as the frequency of the first control signal CS1 to the terminal CK of the D-type flip-flop 50. The D-type flip-flop 50 outputs, from the terminal Q thereof, a signal A whose frequency is half the frequency of the clock signal φ0 to the terminal CK of the D-type flip-flop 51 and AND gates AND1 and AND2. The D-type flip-flop 51 outputs, from the terminal Q thereof, a signal B whose frequency is half the frequency of the signal A to the AND gates AND1 and AND2. According to the outputs from the D-type flip-flops 50 and 51, the AND gate AND1 outputs a signal φ2a to the terminal CK of the D-type flip-flop 52 and a terminal S of a flip-flop 43a. According to the outputs from the D-type flip-flops 50 and 51, the AND gate AND 2 outputs a signal φ2b to the terminal R of the D-type flip-flop 50, the terminal R of the D-type flip-flop 51, the terminal CK of the D-type flip-flop 53, and a terminal S of a flip-flop 43b.

With the above-mentioned operation, the signal φ2a from the AND gate AND1 is high and has a phase difference of 120° with respect to the first control signal CS1. The signal φ2b from the AND gate AND2 has a phase difference of 240° with respect to the first control signal CS1 and momentarily becomes high. When the signal φ2b becomes high, the D-type flip-flops 50 and 51 are reset to initial states.

In this way, the power source apparatus and the method of controlling the power source apparatus according to Embodiment 3 employ a plurality of time constant circuits in the second controller 20, to control a plurality of switching elements. Like Embodiment 1, the present embodiment minimizes noise and ripples and reduces the size and cost of the apparatus.

According to the present embodiment, a plurality of step-up circuits (switching elements) carry out a power factor correction operation at different phases (with phase differences of 120 degrees according to the present embodiment) and the same ON time. The present embodiment employs the sum of currents passing through the step-up circuits as an input current to a load, to minimize noise and current ripples.

According to the present embodiment, the second controller 20 has two time constant circuits to control ON/OFF of two switching elements. By increasing the number of units each storing a state of the first control signal CS1, more switching elements can be controlled.

### Embodiment 4

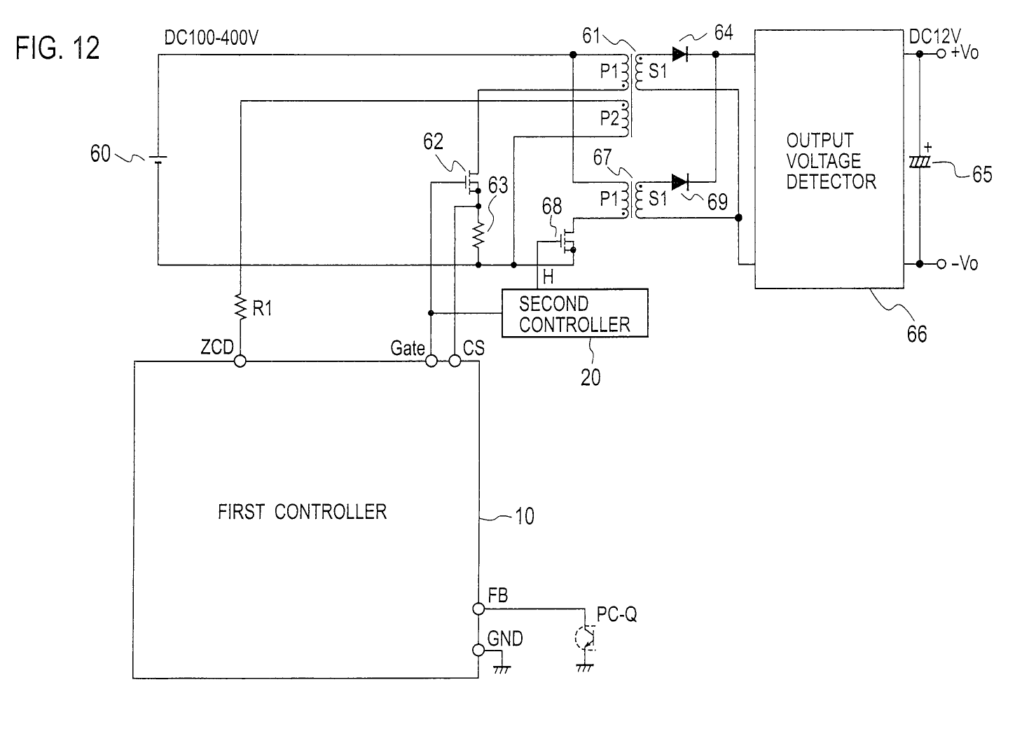

FIG. 12 is a circuit diagram illustrating a power source apparatus according to Embodiment 4 of the present invention. In FIG. 12, the power source apparatus has a DC power source 60, a transformer 61 having a primary winding P1, a secondary winding S1, a tertiary winding P2, and a magnetic core, a switching element 62, a detector resistor 63 to detect a current passed to the switching element 62, a first controller 10, a rectifying element 64, a smoothing capacitor 65, an output voltage detector 66, a transformer 67 having a primary winding P1, a secondary winding S1, and a magnetic core, a switching element 68, a rectifying element 69, and a second controller 20.

The DC power source 60 is expressed in terms of the DC voltage generator stipulated in the claims. The DC power source of the present invention has a plurality of voltage converters connected in parallel with one another and each having a switching element configured to convert the DC voltage generated by the DC voltage generator into a predetermined DC voltage. The two flyback converters arranged in the power source apparatus of the present embodiment is expressed in terms of the voltage converters as stipulated in the claims. One of the flyback converters has the transformer 61, switching element 62, rectifying element 64, and smoothing capacitor 65 and the other consists of the transformer 67, switching element 68, rectifying element 69, and smoothing capacitor 65. As to the present embodiment, each flyback converter is expressed in terms of the voltage converter stipulated in the claims.

The first controller 10 is expressed in terms of the first controller stipulated in the claims and generates a first control signal to control ON/OFF of the switching element (the switching element 62 of the present embodiment) of one of the voltage converters.

The second controller 20 is expressed in terms of the second controller stipulated in the claims, and according to the first control signal generated by the first controller 10, controls ON/OFF of the switching elements (the switching element 68 of the present embodiment) other than the switching element 62 controlled by the first controller 10. The configuration and operation of the second controller 20 are the same as those of the second controller 20 of any one of Embodiments 1 and 2, and therefore, will not be explained again.

The output voltage detector 66 incorporates a photocoupler PC-D and has a function of feeding back through the photocoupler PC-D an error signal, which has been obtained between a secondary-side output voltage Vo and a reference voltage, to the primary side.

Operation of Embodiment 4 will be explained. The present embodiment basically operates like a conventional flyback converter. In each flyback converter, the switching element (62, 68) turns on to apply a DC voltage to the transformer (61, 67), thereby accumulating energy in the transformer. Thereafter, the switching element (62, 68) turns off and the transformer (61, 67) discharges the energy through the rectifying element (64, 69) connected to the secondary winding S1 of the transformer (61, 67), to output a predetermined DC voltage.

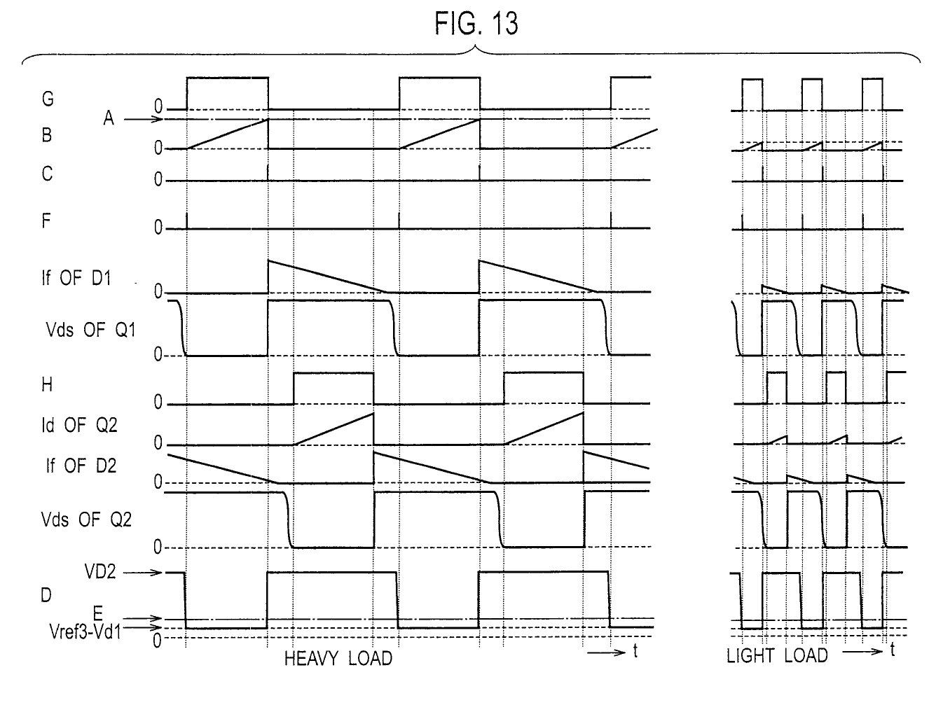

FIG. 13 is a waveform diagram illustrating voltages and currents in the power source apparatus of the present embodiment. In FIG. 13, G is the first control signal to control the switching element 62 and H is the second control signal to control the switching element 68.

As illustrated in FIG. 13, the second controller 20 generates the second control signal that is used to control each (the switching element 68 of the present embodiment) of the switching elements other than the switching element 62 controlled by the first controller 10 in such a way that the switching element other than the switching element 62 has a different phase from the first control signal generated by the first controller 10 and the same ON time as the first control signal.

Even if the frequency of the first control signal changes according to a change in load conditions, the second controller 20 provides the second control signal with the predetermined phase difference and the same ON time according to the first control signal.

In this way, the power source apparatus and the method of controlling the power source apparatus according to the embodiment employ as the voltage converter a flyback converter instead of a step-up chopper. Like the power source apparatuses of Embodiments 1 and 2, the power source apparatus of the present embodiment minimizes noise and ripples and reduces the size and cost of the apparatus.

As mentioned above, the power source apparatus according to each embodiment of the present invention minimizes noise and ripples and reduces the size and cost of the apparatus.

The present invention is applicable to power source apparatuses and methods of controlling the power source apparatuses that must minimize noise and ripples.

This application claims benefit of priority under 35USC §119 to Japanese Patent Application No. 2008-150825, filed on Jun. 6, 2008, the entire content of which is incorporated by reference herein. Although the invention has been described above by reference to certain embodiments of the invention, the invention is not limited to the embodiments described above. Modifications and variations of the embodiments described above will occur to those skilled in the art, in light of the teachings. The scope of the invention is defined with reference to the following claims.

What is claimed is:

1. A power source apparatus comprising:
a DC voltage generator configured to generate a DC voltage;
a plurality of voltage converters connected in parallel with one another and each having a switching element configured to convert the DC voltage generated by the DC voltage generator into a predetermined DC voltage;
a first controller configured to generate a first control signal for controlling ON/OFF of one of the switching elements contained in the plurality of voltage converters; and
a second controller configured to control, according to the first control signal, ON/OFF of the switching elements other than the switching element controlled by the first controller.

2. The power source apparatus of claim 1, wherein
each of the plurality of voltage converters is a step-up-chopper-type circuit.

3. The power source apparatus of claim 1, wherein
each of the plurality of voltage converters is a flyback-converter-type circuit.

4. The power source apparatus of claim 1, wherein
the second controller controls each of the switching elements other than the switching element controlled by the first controller in such a way as to have a different phase from the first control signal and have the same ON time as the first control signal.

5. The power source apparatus according to claim 4, wherein the second controller comprises:
a phase detector configured to detect a phase of the first control signal;
an ON time detector configured to detect an ON time of the first control signal; and
a control signal generator configured to generate, according to the detected phase and ON time, a second control signal for separately controlling the switching elements other than the switching element controlled by the first controller.

6. The power source apparatus of claim 1, wherein the second controller comprises
a time constant circuit configured to store a state of the first control signal.

7. The power source apparatus of claim 1, wherein the second controller comprises
a counter configured to store a state of the first control signal.

8. A method of controlling a power source apparatus that includes a DC voltage generator to generate a DC voltage and a plurality of voltage converters connected in parallel with one another and each having a switching element to convert the DC voltage into a predetermined DC voltage, comprising:
generating a first control signal for controlling ON/OFF of one of the switching elements contained in the plurality of voltage converters;
detecting a phase of the first control signal;
detecting an ON time of the first control signal; and
according to the detected phase and ON time, generating a second control signal for separately controlling each of the switching elements other than the switching element controlled according to the first control signal in such a way as to have a different phase from the first control signal and have the same ON time as the first control signal.
